(19) United States
(12) Patent Application Publication
(10) Pub. No.: US 2012/0020083 A1
(43) Pub. Date: Jan. 26, 2012

(54) REFLECTOR WITH MIXING CHAMBER

(75) Inventors: Teunis Willem Tukker, Eindhoven (NL); Johannes Petrus Maria Ansems, Hulsel (NL); Denis Joseph Carel Van Oers, Bocholt (BE)

(73) Assignee: KONINKLIJKE PHILIPS ELECTRONICS N.V., EINDHOVEN (NL)

(21) Appl. No.: 13/262,468

(22) PCT Filed: Mar. 29, 2010
(86) PCT No.: PCT/IB2010/051348

§ 371 Date: Sep. 30, 2011

(30) Foreign Application Priority Data
Apr. 2, 2009 (EP) 09157178.6

(51) Int. Cl. F21V 13/04

(52) U.S. Cl. 362/235

(57) ABSTRACT

A lighting unit (1), comprising a bowl shaped reflector (6), and a plurality of point shaped light sources (2) arranged inside the reflector. The unit further comprises a mixing chamber (4) in which the point shaped light sources (2) are arranged, and a scattering layer (5) covering the mixing chamber (4). The scattering layer (5) is partially reflecting and partially transmitting, thereby ensuring that light emitted by the point shaped light sources (2) is mixed in the mixing chamber (4) before reaching the reflector.

This allows light emitted from the mixing chamber via the reflector to be conceived as one beam. In use, light from the point shaped light sources may be reflected by the scattering layer and then scattered by the scattering layer so that the reflector generates a beam similar to a halogen beam.

### FIELD OF THE INVENTION

The present invention relates to a lighting unit.

### BACKGROUND OF THE INVENTION

Halogen reflector lamps are very popular products with a large market and it has become interesting to replace the halogen burner with a plurality of point shaped light sources, such as LEDs. In particular, it is desirable to provide a reflector lamp with LEDs that provide the same light intensity as a reflector with a halogen burner.

Today, there are commercially available LED based replacements for halogen lamps, for example Amazon.co.uk markets a “Full Spectrum MR 16 LED replacement for halogen” in which a plurality of LEDs have been arranged in a reflector of MR 16 type. A problem with this lamp is that the light from the plurality of light sources will provide an illumination that is not perceived as that coming from a halogen burner. For example, the intensity distribution of the resulting beam will not be satisfactory.

### SUMMARY OF THE INVENTION

The object of the present invention is to provide a reflector with a plurality of point formed light sources so that the point formed light sources can generate one beam where the output is perceived as only one light source with a homogeneous illumination pattern.

This object is fulfilled by a lighting unit, comprising a bowl shaped reflector, and a plurality of point shaped light sources arranged inside the reflector, a mixing chamber in which the point shaped light sources are arranged, a scattering layer covering the mixing chamber, said scattering layer being partially reflecting and partially transmitting, thereby ensuring that light emitted by the point shaped light sources is mixed in the mixing chamber before reaching the reflector.

This allows light emitted from the mixing chamber via the reflector to be conceived as one beam. In use, light from the point shaped light sources may be reflected by the scattering layer and then scattered by the scattering layer so that the reflector generates a beam similar to a halogen beam.

The term point shaped light source should be construed as a light source that emits light with a light intensity with the shape of a point e.g. a solid state light source such a LED.

In an embodiment the bowl shaped reflector has an inner neck portion, a front opening, and an intermediate portion, and wherein the mixing chamber is located such that the scattering layer is located closer to the neck portion than the front opening.

For example a reflective layer may be provided in a bottom of the mixing chamber. This is advantageous because it provides that part of the light is reflected a number of times between the reflective layer in the bottom of the mixing chamber and the scattering layer on the top of the mixing chamber. In particular the bottom of the mixing chamber may comprise a Printed Circuit Board (PCB) onto which the point shaped light sources are arranged.

The mixing chamber may have an essentially symmetrical cross section, such as a circular cross-section. Such symmetry allows an efficient matching of the light emitted from the chamber and the bowl shaped reflector, which often has a circular cross-section.

The scattering layer can be formed as a coating on a transparent substrate. The scattering layer may e.g. have a reflectivity above 80%. The coating may comprise TiO2, or any material with similar properties. The scattering can be generated by at the surface or in the volume. This is advantageous since it provides a high reflectivity.

The outer rim of the top of the mixing chamber can be provided with a diffusing film such as a holographic film. This is an advantage since it provides for a better mixing of the light emitted by the point shaped light sources.

The point shaped light sources can be phosphor converted white LED light sources. This reduces the visibility of the LED to LED fluctuations. Furthermore it reduces the observed brightness of the light source.

For example the mixing chamber and the scattering layer may be adapted to emit light from the reflector resulting in a beam with a beam angle between 10°-100° Full Width Half Maximum (FWHM) such as 20°-25° FWHM.

It is noted that the invention relates to all possible combinations of features recited in the above.

### BRIEF DESCRIPTION OF THE DRAWINGS

This and other aspects of the present invention will now be described in more detail, with reference to the appended drawings showing a currently preferred embodiment of the invention. Like numbers refer to like features throughout the drawings.

FIG. 1 is a partially broken away, exploded perspective view of a reflector lamp according to an embodiment of the present invention.

FIG. 2 shows the intensity profile of the reflector output from the lamp in FIG. 1.

### DETAILED DESCRIPTION

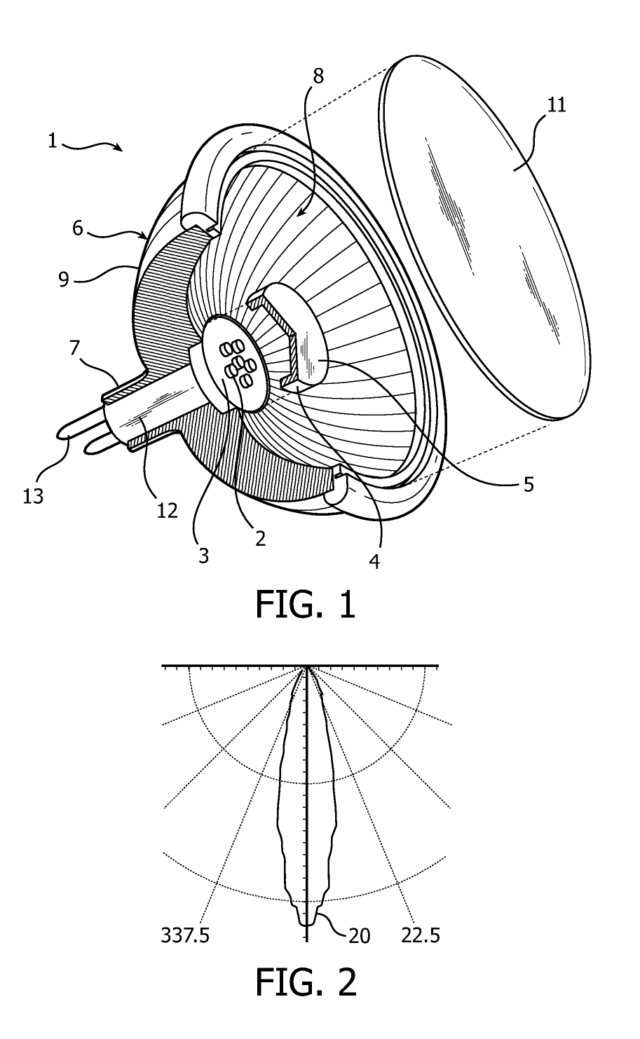

The reflector lamp 1 in FIG. 1 comprises a bowl shaped reflector 6 and a plurality of point shaped light sources 2, in the illustrated example six LEDs 2, which are arranged close to each other inside the reflector. The reflector 6 typically has an inner neck portion 7, a front opening 8, and an intermediate portion 9. It may be e.g. a MR16 reflector. A transparent, protective cover 11 is arranged in the opening 8 of the reflector.

The LEDs 2 are typically mounted on a PCB layer 3, which is electrically connected to contacting pins 13, embedded in a plug structure 12. The plug structure 12 and pins 13 are formed to be insertable and electrically connectable to a socked adapted to receive the lamp 1.

The LEDs 2 are covered by a cover 4 having a cavity that is large enough for the LEDs 2 with their sub mounts, so as to form a mixing chamber. The bottom of a mixing chamber 4, i.e. in the present case the PCB layer 3, can be reflective. For example, the PCB layer 3 is covered by a reflective layer e.g. in the form of a Microcellular Reflective (MCPET) sheet. Alternatively the reflective layer could be made of TiO2. Preferably the reflective layer has a reflectivity above 80%. The reflective layer on the PCB provides for specular reflection of the rays.

The cover 4 preferably has a cross section that resembles a circle, such as hexagonal, octagonal, or, as in the presently illustrated case, circular. Further, the illustrated cover 4 is formed as a straight cylinder, but also a conical or tapered shape is possible. The cover 4 can be made of plastic or any similarly suitable material.

The upper surface of the cover 4 is formed by a scattering layer 5 that is partially reflecting and transmitting. This layer 5 ensures that light emitted by the LEDs 2 is partly mixed in the mixing chamber 4 before being partly transmitted through the scattering layer 5. Preferably the scattering layer 5 is a TiO2 coating.

The reflectivity and scattering of the scattering layer 5, and optionally the reflectivity of the bottom layer 3 has the effect to mix the light emitted by the LEDs 2 to some degree. It has been calculated that with a design according to FIG. 1, 85% of the light is reflected and scattered at least once. If the LEDs 2 are phosphor converted white light sources this amount of mixing is enough to reduce the visibility of the LED to LED fluctuations. The LED to LED fluctuations will be reduced because each LED is unique so e.g. the color of the LEDs never are exactly the same and consequently there will be color differences and flux differences. Furthermore the mixing reduces observed brightness of the light source.

Preferably the mixing chamber 4 containing the LEDs 2, and the scattering layer 5, are located closer to the neck portion 7 than the opening 8 of the reflector, i.e. typically at a distance from the opening.

When light is emitted from the LEDs 2, light transmitted through the scattering layer 5 is reflected by the reflector 6 to generate a beam having essentially homogenous intensity distribution. By arranging the mixing chamber 4 at a suitable distance from the opening of the reflector, the generated beam will have approximately the same beam performance as a halogen burner.

The mixing of the LEDs 2 could be increased further by applying a diffusing film, e.g. in form of holographic film on the outer rim of the mixing chamber 4. The film may have a beam diffusion of e.g. 30×1°. This will further reduce the visibility of the LEDs 2.

FIG. 2 shows the performance of the reflector lamp 1 in FIG. 1, indicated by reference 20. The beam width is 22° FWHM (Full Width Half Maximum) and the centre intensity is 2.2 cd/lm. So for 6 LEDs with an output of 100 lm each the centre intensity is 1320 cd. A halogen (50 W) and a CDM (20 W) reflector lamps have a centre intensity of 4000 cd. So the intensity of the reflector lamp 1 is comparable to today's products.

The person skilled in the art realizes that the present invention by no means is limited to the preferred embodiments described above. On the contrary, many modifications and variations are possible within the scope of the appended claims. For example, the number and light sources may be varied.

1. A lighting unit, comprising:
a bowl-shaped reflector, and
a plurality of point shaped light sources arranged inside the reflector,
a mixing chamber in which the point shaped light sources are arranged, and
a scattering layer (5) covering the mixing chamber, said scattering layer being partially reflecting and partially transmitting, thereby ensuring that light emitted by the point shaped light sources is mixed in the mixing chamber before reaching the reflector.

2. A lighting unit according to claim 1, wherein the bowl-shaped reflector has an inner neck portion, a front opening, and an intermediate portion, and wherein the mixing chamber is located such that the scattering layer is located closer to the neck portion than the front opening.

3. A lighting unit according to claim 1, further comprising a reflective layer in a bottom of the mixing chamber.

4. A lighting unit according to claim 1, wherein the bottom of the mixing chamber comprises a PCB onto which the point shaped light sources are arranged.

5. A lighting unit according to claim 1, wherein the mixing chamber has a circular cross-section.

6. A lighting unit according to claim 1, wherein the scattering layer (5) has a reflectivity above 80%.

7. A lighting unit according to claim 1, wherein the scattering layer comprises TiO₂.

8. A lighting unit according to claim 1, wherein the outer rim of the top of the mixing chamber includes a diffusing film.

9. A lighting unit according to claim 8 wherein the diffusing film is a holographic film.

10. A lighting unit according to claim 1, wherein the point shaped light sources are phosphor converted white LED light sources.

11. A lighting unit according to claim 1, wherein the mixing chamber and the scattering layer are adapted to emit light from the reflector resulting in a beam with a beam angle between 10°-100° Full Width Half Maximum.

12. A lighting unit according to claim 11, wherein the beam angle is between 20°-25° Full Width Half Maximum.

13. A lighting unit according to claim 1, further adapted to retrofit into a luminaire employing a halogen light source.

14. (canceled)
